(19) United States
(12) Patent Application Publication
(10) Pub. No.: US 2009/0073606 A1
(43) Pub. Date: Mar. 19, 2009

(54) AIRFLOW DIVERTER PLATE IN A DATA STORAGE DEVICE

(75) Inventors: Xiaohong Sun, Prior Lake, MN (US); Lance L. Thoresen, Burnsville, MN (US)

Correspondence Address: SEAGATE TECHNOLOGY LLC C/O WESTMAN;CHAMPLIN & KELLY, P.A., SUITE 1400, 900 SECOND AVENUE SOUTH, MINNEAPOLIS, MN, 55402-3244, US

(73) Assignee: Seagate Technology LLC, Scotts Valley, CA (US)

(21) Appl. No.: 11/857,914

(22) Filed: Sep. 19, 2007

(51) Int. Cl. G11B 5/012

(52) U.S. Cl. 360/97.01

(57) ABSTRACT

A data storage medium has a spinning outer diameter that generates a flow stream. A hub joins to actuator arms that are separated by a slot. The outer diameter and the flow stream pass through the slot. A support plate projects from the hub into the slot and faces in a direction that is generally transverse to the flow stream. A diverter plate is positioned in the slot upstream of the support plate. The diverter plate diverts the flow stream toward the outer diameter.

### BACKGROUND

In disc drives, read/write heads access data on data storage discs. As disc drives improve, the data capacity of disc drives is increasing while the physical size of disc drives is decreasing. As a result, the track density in tracks per inch (TPI) is increasing and the width of a data track is decreasing in newer disc drive designs. In turn, improvements in non-repeatable runout (NRRO) have also been required. Non-repeatable runout is caused by many sources, including turbulence in air flow around the discs, actuator arms, and pivot hubs of the disc drive. Turbulence in air flow is a particularly significant contributor to NRRO and is difficult to control.

### SUMMARY

In a data storage system, a diverter plate including an airflow control surface region and a support region that is adapted to be supported on a printed circuit support plate projecting from an actuator pivot hub in a data storage device. The support region joins to the airflow control surface region at an angle such that the airflow control surface region diverts a flow stream toward a spinning outer diameter of a data storage medium in the data storage device.

These and various other features and advantages will be apparent from a reading of the following Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is an oblique view of a disc drive.

FIG. 2 illustrates an oblique view of a portion of a data storage device.

FIG. 3 illustrates a cross sectional view of the data storage device shown in FIG. 2.

FIG. 4 illustrates an enlarged view of a portion of FIG. 3.

FIGS. 5A-5C illustrate diverter plates.

FIG. 6 illustrates an oblique view of the diverter plate of FIG. 5A.

FIG. 7 illustrates an oblique view of a component that comprises multiple diverter plates.

FIG. 8 illustrates a bar graph of improvements related to non-repeatable runout (NRRO) performance for an exemplary disc drive.

FIG. 9 illustrates a table of percentage noise improvements for four sample disc drives when a diverter plate is added.

### DETAILED DESCRIPTION

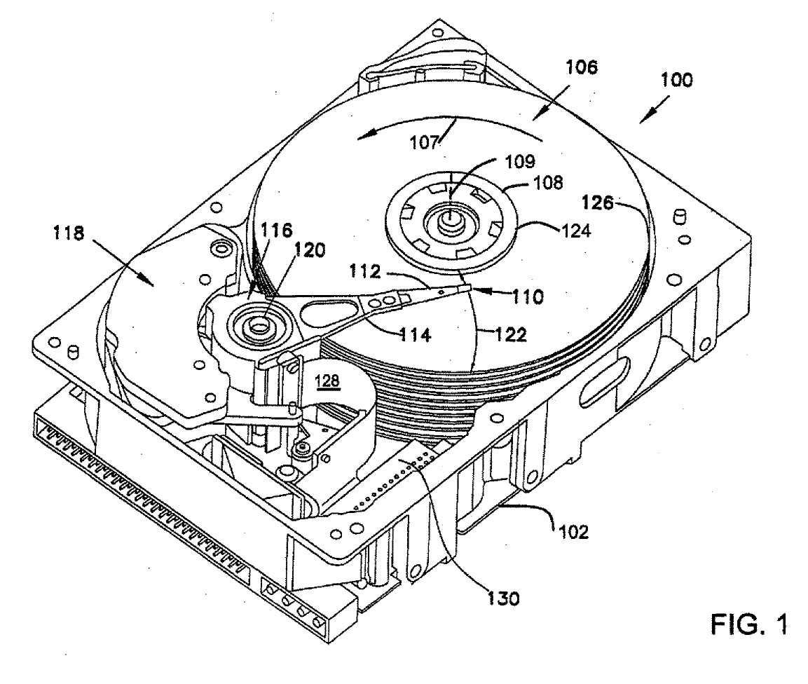

FIG. 1 is an oblique view of a disc drive 100 in which disclosed aspects are useful. Disc drive 100 includes a housing with a base 102 and a top cover (not shown). Disc drive 100 further includes a disc pack 106, which is mounted on a spindle motor (not shown) by a disc clamp 108. Disc pack 106 includes a plurality of individual discs, which are mounted for co-rotation in a direction 107 about central axis 109. Although FIG. 1 illustrates multiple discs, those skilled in the art should understand that a single disc can be used in disc drive 100. Each disc surface has an associated disc head slider 110 which is mounted to disc drive 100 for communication with the disc surface. The disc head sliders 110 are electrically connected by way of a flex circuit 128 to electronics 130. In the example shown in FIG. 1, sliders 110 are supported by suspensions 112 which are in turn attached to track accessing arms 114 of an actuator 116. The actuator shown in FIG. 1 is of the type known as a rotary moving coil actuator and includes a voice coil motor (VCM), shown generally at 118. Voice coil motor 118 rotates actuator 116 with its attached heads 110 about a pivot shaft 120 to position heads 110 over a desired data track along an arcuate path 122 between a disc inner diameter 124 and a disc outer diameter 126. Voice coil motor 118 is driven by electronics 130 based on signals generated by heads 110 and a host computer (not shown). The disc drive 100 illustrated in FIG. 1 is merely exemplary, and other types of data storage devices can be used as well.

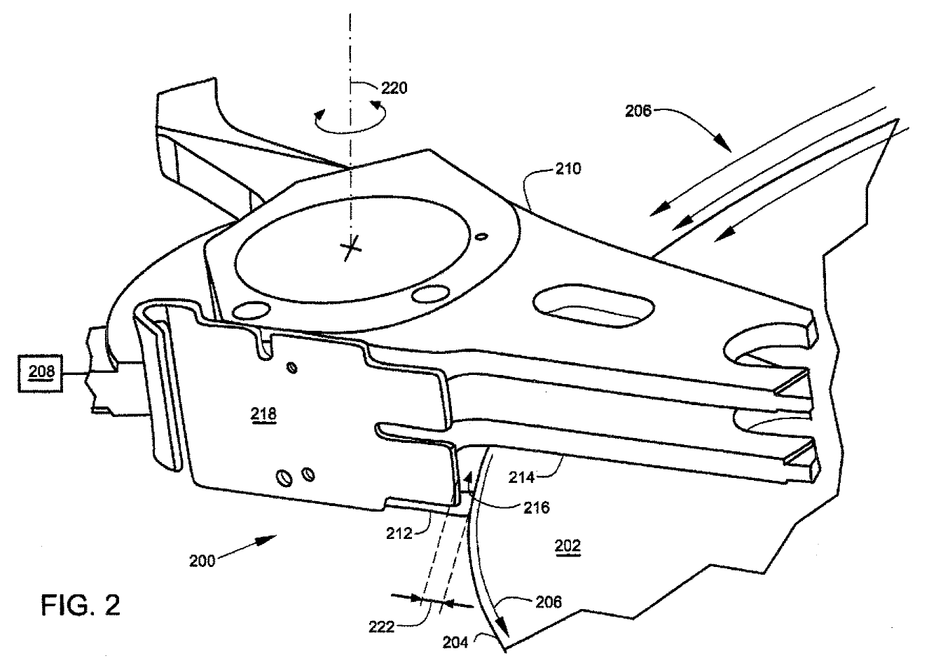

FIG. 2 illustrates an oblique view of a portion of a data storage device 200. The data storage device 200 comprises data storage discs, only one of which (data storage disc 202) is illustrated in FIG. 2. The disc 202 spins and has a spinning outer diameter 204. The spinning of the outer diameter 204 generates a flow stream 206 adjacent the outer diameter 204.

The data storage device 200 comprises an actuator 208 operated by a voice coil motor (such as voice coil motor 118 of FIG. 1) and coupled to an actuator pivot hub 210. The actuator pivot hub 210 joins to actuator arms, such as first and second actuator arms 212, 214. The first and second actuator arms 212, 214 are separated by a slot 216 and are positioned above and below the disc 202, respectively. The spinning outer diameter 204 and the flow stream 206 pass through the slot 216.

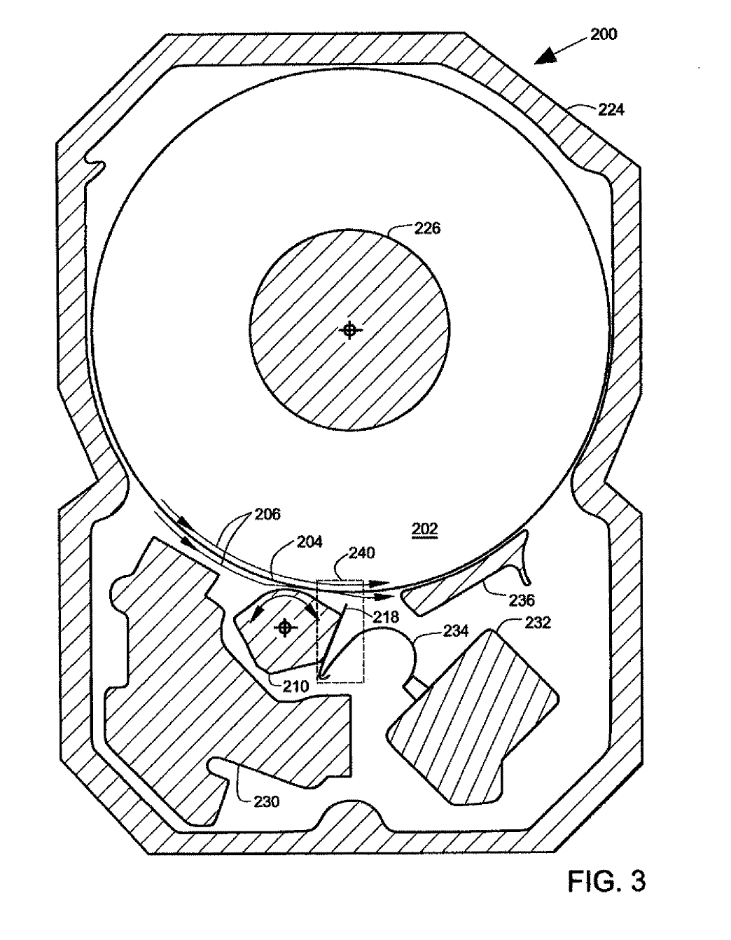

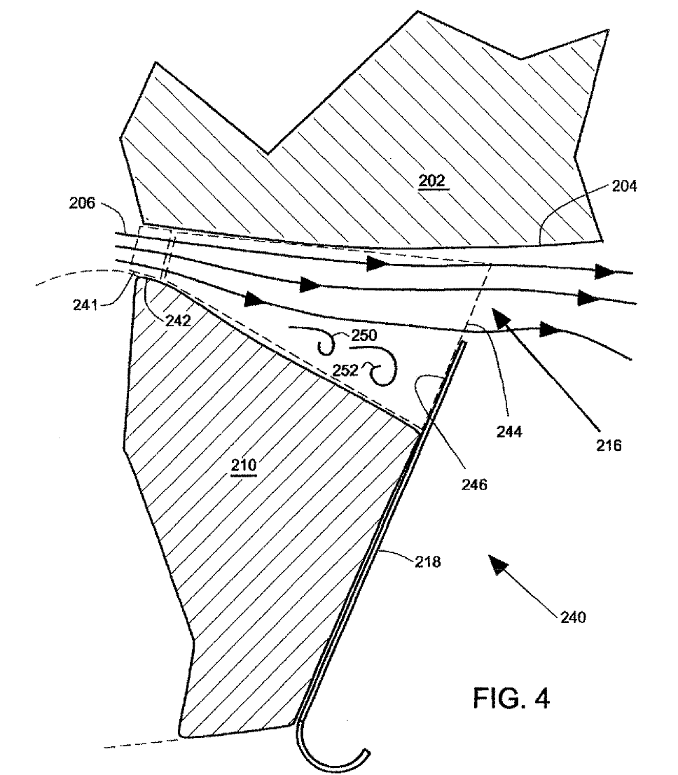

The data storage device comprises a printed circuit card support plate 218 that is attached to and projects from the actuator pivot hub 210 into the slot 216 toward the spinning outer diameter 204 of the disc 202. The support plate 218 supports a flex circuit (flexible printed circuit such as flex circuit 128 in FIG. 1). The support plate 218 is mounted to the actuator pivot hub 210 and moves together with the actuator pivot hub 210 and the actuator arms 212, 214. The actuator pivot hub 210 and the actuator arms 212, 214 pivot around a pivot axis 220. In some pivotal positions, the support plate 218 is closer to the outer diameter 204. In other pivotal positions, the support plate 218 is farther from the outer diameter 204. Thus, the spacing 222 between the outer diameter 204 and the support plate 218 is highly variable over the course of regular operation. The aerodynamic conditions in the slot 216 are also variable due to change in the spacing 222 with pivotal motion around the pivot axis 220. The flow stream 206 encounters variable aerodynamic conditions as the flow stream 206 passes between the outer diameter 204 and the support plate 218. The aerodynamic flow conditions are described in more detail below in connection with FIGS. 3-4.

FIG. 3 illustrates a cross sectional view of the data storage device 200. The cross-sectional view shown in FIG. 3 is generally along a plane that passes between two data storage discs (such as between disc 202 and an overlying disc (not illustrated). Various features of the data storage device 200 that block air flow along the cross-sectional plane are illustrated in cross-section. Air flow blocking features include a disc housing 224, a storage disc hub 226, a voice coil motor 230, an electronics assembly 232, a flex circuit 234, a flow guide 236, the actuator pivot hub 210 and the support plate 218. A portion 240 (indicated generally by a dashed line box) of FIG. 3 is illustrated in an enlarged form in FIG. 4.

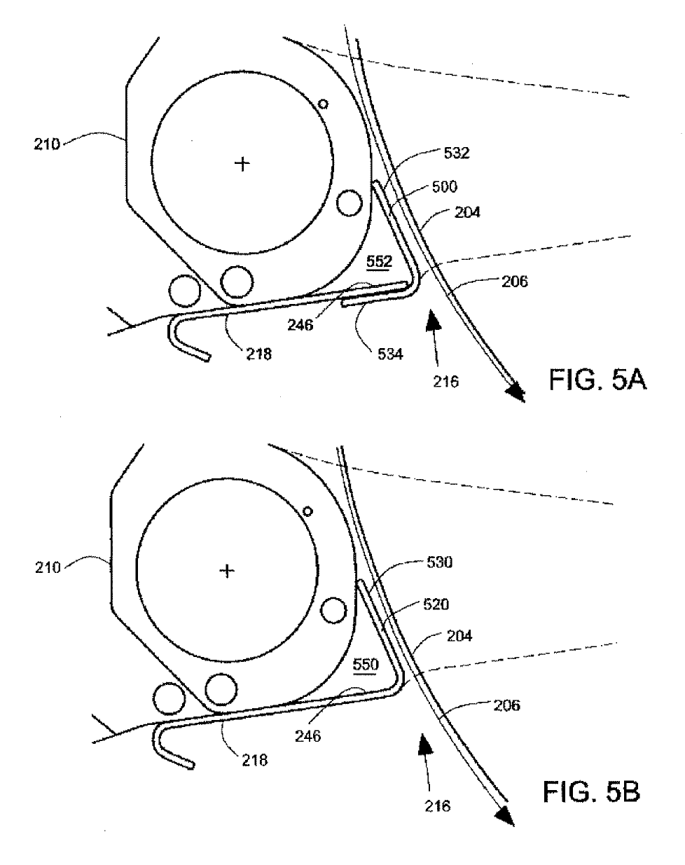

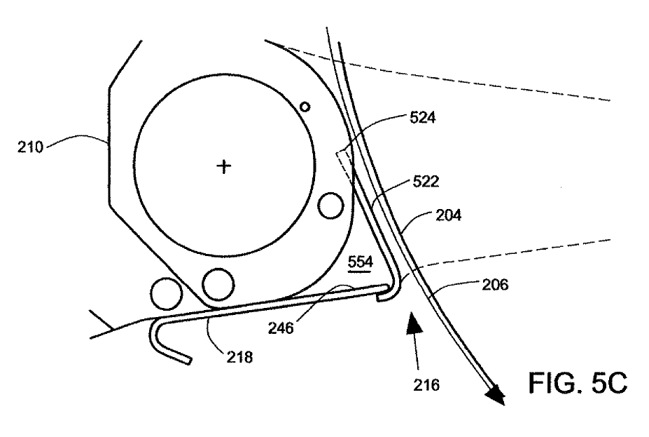

FIG. 4 illustrates an enlarged view of a portion 240 (FIG. 3) of the data storage device 200. As illustrated in FIG. 4, the flow stream 206 flows past the pivot hub 210 at a narrowed region 241 between the disc outer diameter 204 and a nose 242 of the pivot hub 210. As the flow stream 206 emerges from the narrowed region 241, it flows into a widening nozzle region 244 (indicated by a dashed line box). In the widening nozzle region 244, the flow stream 206 impacts a surface 246 of the support plate 218. Waves of random turbulences (such as turbulences 250, 252) form in the widening nozzle region. The random turbulences 250, 252 (also called vortices) affect surfaces of the pivot hub 210 and the support plate 218. The random turbulences 250,252 rotate and generate random noise in the angular position of the pivot hub 210. This rotation and generation of random noise adversely affects actuator arms 214, 216, and corresponding tracking of the sliders (such as sliders 110 in FIG. 1) on the surface of disc 202. The turbulence increases the position error signal. The turbulence increases non-repeatable runout (NRRO). The turbulence also can excite resonance modes of the pivot hub 210 and of the actuator arms 212, 214. This tracking noise due to waves of turbulence in the region 244 is reduced by the addition of a diverter plate in region 244. A diverter plate diverts the flow stream 206 toward the outer diameter 204 and away from an air space between the support plate 218 and the actuator pivot hub 210. Vortices in an air space between the support plate 218 and the actuator pivot hub 210 are suppressed by use of the diverter plate as the diverter plate shields the air space from the flow stream 206. Suppression of the vortices can reduce non-repeatable runout (NRRO) and improve the performance of the data storage device. Aspects of diverter plates are described below in connection with FIGS. 5A-5C.

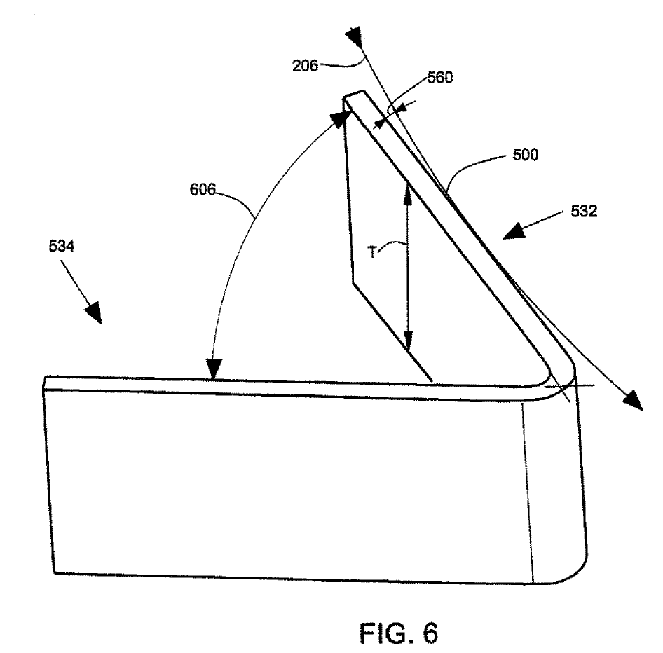

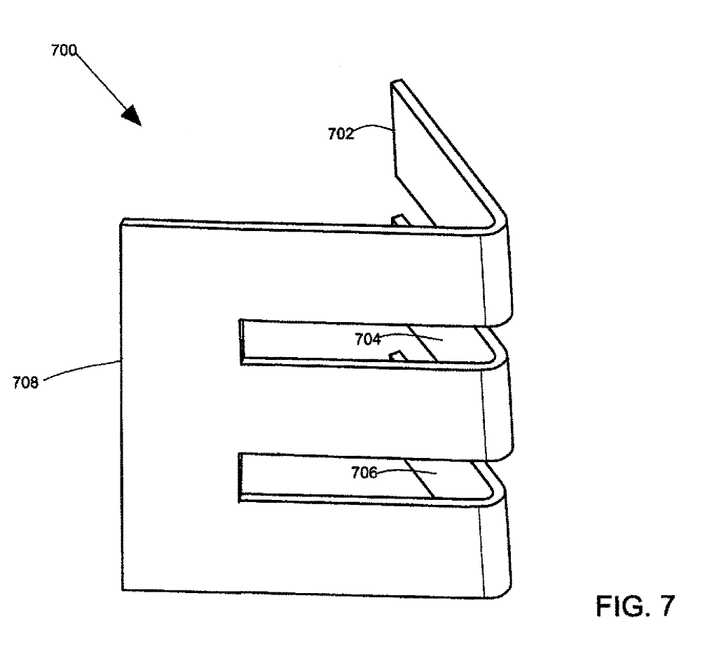

FIG. 5A illustrates an embodiment of a diverter plate 500. The diverter plate 500 is positioned in the slot 216 to divert the flow stream 206. The diverter plate 500 includes an airflow control surface 532 that is positioned upstream of the support plate 218. The flow stream 206 is diverted and does not significantly affect the surface 246 of the support plate 218. The flow stream 206 strikes the diverter plate 500 at an oblique angle (angle 560 in FIG. 6). The diverter plate 500 diverts a portion of the flow stream 206 toward the outer diameter 204 to prevent the development of large turbulences in the region around the pivot hub 210. The generation of random turbulence (such as turbulence 250, 252 in FIG. 4) is largely suppressed by use of the diverter plate 500.

In one aspect, the diverter plate 500 is formed of a thin strip of material that is attached to the support plate 218. The thin strip has a preferred low mass and can rotate with the support plate 218 and pivot hub 210 without significantly increasing rotational inertia and without significantly disturbing the balance of the pivot hub 210. Use of the diverter plate 500 avoids thickening the size of the pivot hub 210, which would adversely affect rotational inertia and balance. In another aspect, the diverter plate 500 is formed of sheet metal. The spinning outer diameter 204 and the diverter plate 500 form a converging nozzle that suppresses formation of vortices in the flow stream 206. The diverter plate 500 is positioned to shield an air space 552 between the diverter plate 500 and the actuator pivot hub 210 from the flow stream 206. Similar advantages are obtained with the diverter plates illustrated in FIGS. 5B, 5C.

FIG. 5B illustrates a second aspect of a diverter plate 520. The diverter plate 520 is positioned in the slot 216 to divert the flow stream 206. The diverter plate 520 is positioned upstream of the support plate 218 and is integrally formed with the support plate 218. The flow stream 206 is diverted and does not impact the surface 246 of the support plate 218. Random turbulence (such as turbulence 250, 252 in FIG. 4) is largely suppressed by use of the diverter plate 520. The diverter plate 520 diverts the flow stream 206 toward the outer diameter 204, avoiding large turbulences in the region around the pivot hub 210. The flow stream 206 strikes an airflow control surface 530 of the diverter plate 520 at an oblique angle and turbulence is reduced. The diverter plate 520 is positioned to shield an air space 550 between the diverter plate 520 and the actuator pivot hub 210 from the flow stream 206.

FIG. 5C illustrates a third aspect of a diverter plate 522. The diverter plate 522 is positioned in the slot 216 to divert the flow stream 206. The diverter plate 522 is positioned upstream of the support plate 218. The diverter plate 522 includes an extension 524 that is anchored in the actuator pivot hub 210. In one aspect, the diverter plate 522 comprises an insert that is molded into a plastic resin body of the actuator pivot hub. The flow stream 206 is diverted and does not impact the surface 246 of the support plate 218. Random turbulence (such as turbulence 250, 252 in FIG. 4) is largely suppressed by use of the diverter plate 522. The diverter plate 522 diverts the flow stream 206 toward the outer diameter 204, avoiding large turbulences in the region around the pivot hub 210. The flow stream 206 strikes the diverter plate 522 at an oblique angle and turbulence is reduced. The diverter plate 522 is positioned to shield an air space 554 between the diverter plate 520 and the actuator pivot hub 210 from the flow stream 206.

FIG. 6 illustrates an oblique view of the diverter plate 500. In one aspect, the diverter plate 500 has a thickness T that substantially fills a space between adjacent actuator arms (such as actuator arms 212, 214 in FIG. 2). The diverter plate can be provided with small optional through holes (not illustrated) that fit on pins protruding from the support plate 218 to ensure correct mounting alignment.

The diverter plate 500 comprises an airflow control surface region 532. The diverter plate 500 further comprises a support region 534. The support region 534 is adapted to be supported on a printed circuit support plate projecting from an actuator pivot hub in a disc drive. The support region 534 joins to the airflow control surface region 532 at an angle 606 such that the airflow control surface region diverts a flow stream toward a spinning outer diameter of a data storage disc in the disc drive. The flow stream 206 impacts the control surface region 532 of the diverter plate 500 at an oblique angle 560.

FIG. 7 illustrates an oblique view of a component 700 that comprises multiple diverter plates 702, 704, 706. The component 700 provides convenient installation in a disc drive with multiple discs. The multiple diverter plates 702, 704, 706 are integrally formed with a connection plate 708. The connection plate can be provided with optional through holes (not illustrated) for mounting alignment.

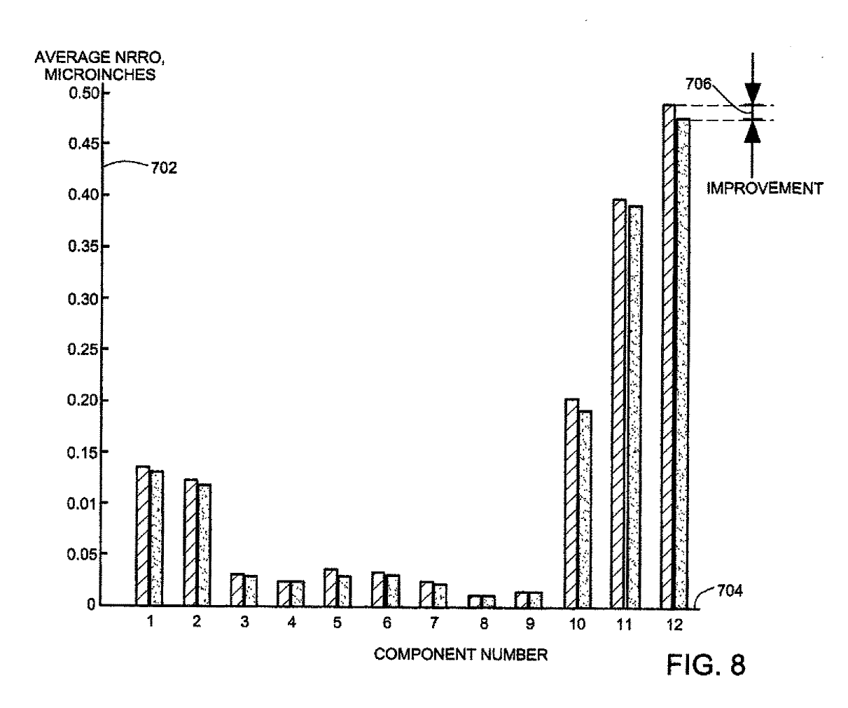

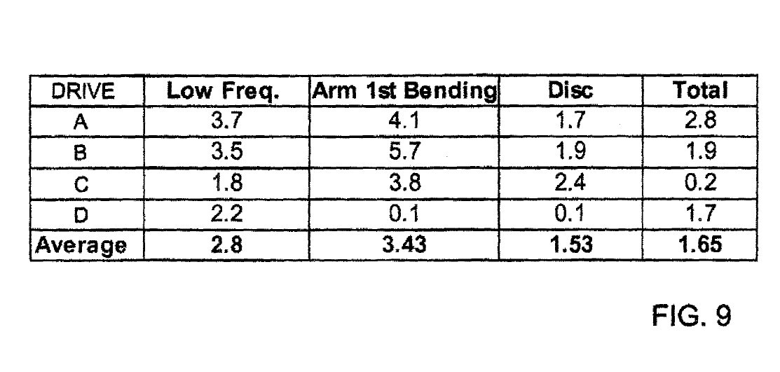

Before describing FIGS. 8 and 9 in detail, affects of airflow and pressure fluctuations within a data storage system will be discussed. An airflow vortex can form in a region (such as region 244 in FIG. 4) between actuator arms (such as actuator arms 212, 214 in FIG. 2) at the juncture of a head stack assembly (HSA) arm root and a printed circuit card (PCC) stiffener (such as support plate 218 in FIG. 2). Air flow vortices (or air pockets) in the region change according to HSA angular location changes as the sliders change position from a disc ID (such as disc ID 124 in FIG. 1) to a disc OD (such as disc OD 126 in FIG. 1). When the HSA seeks from ID to OD, the air flow vortices will change. These vortices induce air pressure fluctuations that act on the PCC stiffener in an off track direction. These air pressure fluctuations can also induce arm-related resonance modes. The air pockets also worsen the shrouding of the discs. As a consequence, Non-repeatable runout (NRRO) or positional error will be worse, especially at low frequencies, arm 1^{st} bending mode and disc modes bins. The track misregistration (TMR) capability is lower with these air pockets.

A diverter plate (such as diverter plates illustrated in FIGS. 5A, 5B, 5C, 6, 7) diverts air flow away from PCC stiffener. The arm root air diverter can be a stand alone part (FIG. 5A), or an integral feature of the PCC stiffener (FIG. 5B), or a feature mounted to the pivot hub (FIG. 5C). It is generally not appropriate to fill the air space between the diverter plate and the pivot hub with solid material, as the solid material would adversely impact HSA inertia and balance, and would worsen the system response time.

The diverter plate eliminates air pockets (eddies) between actuator arms at the juncture of HSA arm root and PCC stiffener. The diverter plate diverts air away from PCC stiffener such that vortices are suppressed in the spaces between arms and the PCC stiffener. Off-track forces and excitations on actuator arms are reduced. Better shrouding is provided to the discs to reduce disc mode. The total NRRO is reduced.

FIG. 8 illustrates a bar graph of improvements in non-repeatable runout (NRRO) performance for an exemplary disc drive with disc track density of about 150 K tracks per inch. A vertical axis 702 represents non-repeatable runout in microinches. A horizontal axis 704 lists sources of non-repeatable runout from different components in the disc drive. The graph shows partial contributions of NRRO from various components 1-11. The diagonally ruled bars represent performance of the disc drive without the use of a diverter plate. The stippled bars represent performance of the disc with the use of a diverter plate. A difference in height 706 of closely adjacent bars represents an improvement of performance provided by the use of diverter plates. Components 1-12 shown in FIG. 8 are as follows:

1. low frequency component

2. actuator arm 1st bending mode

3. coil torsion

4. actuator arm 2nd bending mode

5. head gimbal assembly 1st bending mode

6. actuator arm torsion

7. head gimbal assembly torsion

8. 2nd system mode

9. head gimbal assembly 2nd bending mode

10. other

11. disc

12. total NRRO

The individual mechanical noise components have different noise waveforms, which are generally uncorrelated, and differing amounts of the individual components contribute to the total NRRO (12.) approximately in a root-sum-square (RSS) manner.

FIG. 9 illustrates a table of percentage noise improvements for four sample disc drives A, B, C, D when the diverter plate is added. An average overall total improvement in the position error signal (PES) of 1.65% is obtained by use of the diverter plate.

It is to be understood that even though numerous characteristics and advantages of various disclosed aspects have been set forth in the foregoing description, together with details of the structure and function of disclosed aspects, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the data storage system while maintaining substantially the same functionality without departing from the scope and spirit of the present invention.

What is claimed is:

1. A data storage device, comprising:
a data storage medium with a spinning outer diameter that generates a flow stream adjacent the outer diameter;
an actuator pivot hub joined to first and second actuator arms that are separated by a slot through which the spinning outer diameter and the flow stream pass;
a support plate that projects from the actuator pivot hub into the slot, the support plate facing in a direction that is generally transverse to the flow stream; and
a diverter plate positioned in the slot upstream of the support plate, the diverter plate diverting the flow stream toward the outer diameter.

2. The data storage device of claim 1 wherein the flow stream strikes the air diverter plate at an oblique angle.

3. The data storage device of claim 1 wherein the diverter plate includes a support region that is attached to the support plate.

4. The data storage device of claim 1 wherein the diverter plate is attached to the actuator pivot hub.

5. The data storage device of claim 1 wherein the diverter plate is integrally formed with the support plate.

6. The data storage device of claim 1 and further comprising a second diverter plate that is joined to the diverter plate.

7. The data storage device of claim 1 wherein the diverter plate is positioned to shield an air space between the diverter plate and the actuator pivot hub from the flow stream.

8. The data storage device of claim 1 wherein the diverter plate diverts the flow stream away from the support plate.

9. The data storage device of claim 1 wherein the diverter plate reduces non-repeatible runout.

10. The data storage device of claim 1 wherein the diverter plate has a thickness that substantially fills a spacing between the first and second actuator arms.

11. A method of reducing non-repeatable runout in a data storage device, the method comprising:
spinning an outer diameter of a data storage medium to generate a flow stream adjacent the outer diameter;
joining an actuator pivot hub to first and second actuator arms that are separated by a slot;
passing the spinning outer diameter and the flow stream through the slot;
projecting a support plate from the actuator pivot hub into the slot, the support plate facing in a direction that is generally transverse to the flow stream; and
positioning a diverter plate in the slot upstream of the support plate, the diverter plate diverting the flow stream toward the outer diameter.

12. The method of claim 11 and providing a support region on the diverter plate that attaches the diverter plate to the support plate.

13. The method of claim 11 and integrally forming the diverter plate with the support plate.

14. The method of claim 11 and providing a second diverter plate that is joined to the diverter plate.

15. The method of claim 11 and attaching the diverter plate to the actuator pivot hub.

16. The method of claim 11 and positioning the diverter plate to shield an air space between the diverter plate and the actuator pivot hub from the flow stream.

17. The method of claim 11 and substantially filling a spacing between the first and second actuator arms with a thickness of the diverter plate.

18. A diverter plate, comprising:
an airflow control surface region; and
a support region that is adapted to be supported on a printed circuit support plate projecting from an actuator pivot hub in a data storage device, the support region joining to the airflow control surface region at an angle such that the airflow control surface region diverts a flow stream toward a spinning outer diameter of a data storage medium in the data storage device.

19. The diverter plate of claim 18 wherein the diverter plate is formed of sheet metal.

20. The diverter plate of claim 18 wherein the diverter plate is integrally joined to a second airflow control surface region.
